(19) United States
(12) Patent Application Publication
(10) Pub. No.: US 2025/0334998 A1
(43) Pub. Date: Oct. 30, 2025

(54) CLOCK SYNCHRONIZATION METHOD AND APPARATUS, COMPUTER-READABLE MEDIUM, AND ELECTRONIC DEVICE

(71) Applicant: Tencent Technology (Shenzhen) Company Limited, Shenzhen (CN)

(72) Inventors: Yixue LEI, Shenzhen (CN); Yuhang JIA, Shenzhen (CN)

(21) Appl. No.: 19/263,357

(22) Filed: Jul. 8, 2025

Related U.S. Application Data
(63) Continuation of application No. PCT/CN2024/089468, filed on Apr. 24, 2024.

(30) Foreign Application Priority Data
May 6, 2023 (CN) 202310505289.1

(51) Int. Cl. G06F 1/08

(52) U.S. Cl. CPC G06F 1/08

(57) ABSTRACT

Embodiments of this application provide a clock synchronization method performed by an electronic device. The clock synchronization method includes: obtaining a mapping relationship between a network state parameter and a clock synchronization parameter, the network state parameter representing a network state between a terminal device and a clock server; obtaining a current network state parameter between the terminal device and the clock server when the terminal device and the clock server need to perform clock synchronization; determining a clock synchronization parameter between the terminal device and the clock server corresponding to the current network state parameter based on the mapping relationship; and performing clock synchronization between the terminal device and the clock server based on the clock synchronization parameter.

### CROSS-REFERENCE TO RELATED APPLICATIONS

This application is a continuation application of PCT Patent Application No. PCT/CN2024/089468, entitled “CLOCK SYNCHRONIZATION METHOD AND APPARATUS, COMPUTER-READABLE MEDIUM, AND ELECTRONIC DEVICE” filed on Apr. 24, 2024, which claims priority to Chinese Patent Application No. 2023105052891, entitled “CLOCK SYNCHRONIZATION METHOD AND APPARATUS, COMPUTER-READABLE MEDIUM, AND ELECTRONIC DEVICE” filed with the China National Intellectual Property Administration on May 6, 2023, both of which are incorporated by reference in their entirety.

### FIELD OF THE TECHNOLOGY

This application relates to the field of computer and communication technologies, and specifically, to a clock synchronization method and apparatus, a computer-readable medium, and an electronic device.

### BACKGROUND OF THE DISCLOSURE

Time-sensitive networking (TSN) is a network technology defined by the Institute of Electronic and Electronics Engineers (IEEE) to implement time synchronization and deterministic communication between nodes, and is mainly configured for real-time communication and network control. In addition, time sensitive communications (TSC) of TSN are introduced to a 5th generation mobile communication technology (5G) system, to cause the 5G system to support industrial automated manufacturing applications with precise time control.

### SUMMARY

An embodiment of this application provides a clock synchronization method, performed by an electronic device, including: obtaining a mapping relationship between a network state parameter and a clock synchronization parameter, the network state parameter being configured for representing a network state between a terminal device and a clock server; obtaining a current network state parameter between the terminal device and the clock server when the terminal device and the clock server need to perform clock synchronization; determining a clock synchronization parameter between the terminal device and the clock server corresponding to the current network state parameter based on the current network state parameter and the mapping relationship; and performing clock synchronization between the terminal device and the clock server based on the clock synchronization parameter.

An embodiment of this application provides a non-transitory computer-readable medium, having a computer program stored therein, the computer program, when executed by a processor of an electronic device, causing the electronic device to implement the clock synchronization method according to the above-mentioned embodiment.

An embodiment of this application provides an electronic device, including: one or more processors; and a storage apparatus, configured to store one or more computer programs, the one or more computer programs, when executed by the one or more processors, causing the electronic device to implement the clock synchronization method according to the above-mentioned embodiment.

### BRIEF DESCRIPTION OF THE DRAWINGS

FIG. 1 is a schematic architecture diagram of supporting of time synchronization of an external time domain by a 5G system;

FIG. 2 is a schematic diagram of an exemplary system architecture to which a technical solution in an embodiment of this application may be applied;

FIG. 3 is a flowchart of a clock synchronization method according to an embodiment of this application;

FIG. 4 is a schematic diagram of a transition relationship between a clock hold state and a clock adjustment state according to an embodiment of this application;

FIG. 5 is a schematic diagram of a transition relationship between a clock hold state and a clock adjustment state according to an embodiment of this application;

FIG. 6 is a flowchart of a clock synchronization method according to an embodiment of this application;

FIG. 7 is an interactive flowchart of a clock synchronization process according to an embodiment of this application;

FIG. 8 is a flowchart of a clock synchronization method according to an embodiment of this application;

FIG. 9 is a block diagram of a clock synchronization apparatus according to an embodiment of this application; and

FIG. 10 is a schematic structural diagram of a computer system suitable for implementing an electronic device according to an embodiment of this application.

### DESCRIPTION OF EMBODIMENTS

Exemplary implementations are now described in a more comprehensive manner with reference to the accompanying drawings. However, the exemplary implementations may be implemented in various forms, and are not to be understood as being limited to these examples. On the contrary, the purpose of providing the implementations is to make this application more comprehensive and complete, and to fully convey the concept of the exemplary implementations to a person skilled in the art.

In addition, the features, structures, or characteristics described in this application may be combined in one or more embodiments in any appropriate manner. The following description has many specific details, so that the embodiments of this application can be fully understood. However, a person skilled in the art is to be aware that, technical solutions of this application may be implemented without using all detailed features in the embodiments, one or more specific details may be omitted, or other methods, elements, apparatuses, operations, or the like may be used.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

“A plurality of” mentioned herein means two or more. The term “and/or” is used for describing an association relationship between associated objects and representing that three relationships may exist. For example, A and/or B may represent the following three cases: A exists alone, both A and B exist, and B exists alone. The character “/” generally indicates an “or” relationship between the associated objects.

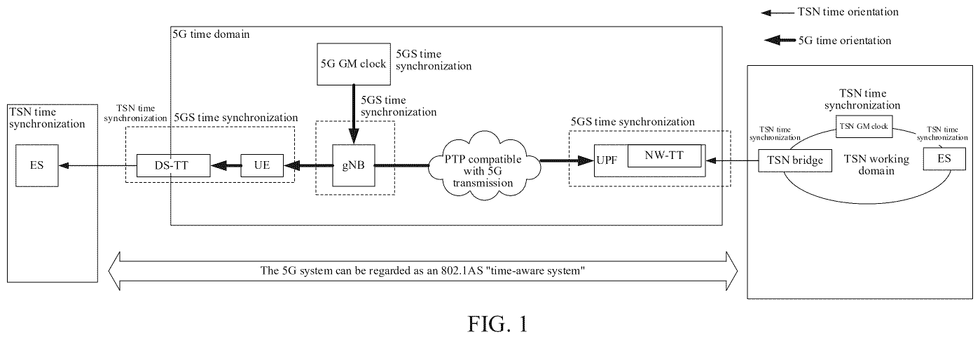

With the development of technologies, time sensitive communications of TSN are introduced to a 5G system, to cause the 5G system to support industrial automated manufacturing applications with precise time control. As shown in FIG. 1, in a system architecture in which the 5G system and the TSN are integrated, the 5G system is integrated into a TSN system as a TSN bridge. The “logical” TSN bridge includes a TSN translator, configured to perform user plane interaction between the TSN system and the 5G system. A function of the TSN translator of the 5G system (5GS) includes a device side TSN translator (DS-TT) and a network TSN translator (NW-TT). A user equipment (UE) in the 5G system is connected to one or more end stations (ESes, which are devices connected to a local area network or a metropolitan area network, and serve as sources and/or destinations of traffic carried on the local area network or the metropolitan area network) in a TSN data network (DN) outside the 5G system by the DS-TT. A user plane function (UPF) is connected to one or more ESes in the TSN data network (DN) by the NW-TT.

To implement a TSN synchronization mechanism, an entire end-to-end 5G system may be considered as an IEEE 802.1AS time aware system. As shown in FIG. 1, there are two time synchronization domains, which are a 5G time domain and a TSN time domain. The 5G system has a time system (for example, a global positioning system (GPS) time) of the 5G system. In FIG. 1, a 5G grandmaster (5G GM) clock is configured to represent a clock domain of the 5G system (namely a 5G time domain).

A gNB in FIG. 1 represents a 5G base station. Each device in the 5G system is synchronized to a 5G clock domain. Devices in the 5G system include: a UPF, a session management function (SMF), a user equipment (UE), a DS-TT, an NW-TT, a next generation (NG)-radio access network (NG-RAN), and the like. An NG interface is an interface between a radio access network and a 5G core network.

As shown in FIG. 1, a clock source of an external TSN time domain is outside the UPF. A device ES on the UE side of the TSN is connected to the UE by the DS-TT, to access a 5G network, and then accesses an external TSN network by the UPF and the NW-TT on the UPF, to perform time synchronization with a clock source of the TSN.

In FIG. 1, a time synchronization message is transmitted by a TSN GM clock through downlink (DL) data, that is, transmitted by a user plane of the UE. The downlink data including the time synchronization message of the TSN GM clock first reaches the NW-TT/UPF to enter the 5G system, then reaches the UE and the DS-TT thereof, and finally reaches the ES on the UE side.

The TSN GM clock identifies a current time in an originTimestamp field of the time synchronization message transmitted by the TSN GM clock. While the user plane of the UE delivers the time synchronization message, the NW-TT marks, on the time synchronization message, a receiving time of the downlink data received by the NW-TT, and updates a CorrectionField value in a data packet to an original CorrectionField value plus a transmission delay value between the NW-TT and an Ethernet bridge port that transmits the message to the NW-TT. Before forwarding the downlink data to the ES, the DS-TT subtracts the current time from the receiving time added by the NW-TT to the downlink data, to obtain a transmission delay value of the time synchronization message in the entire 5G system, accumulates the delay value with a previous transmission time (in CorrectionField of the received time synchronization message) from a TSN grandmaster clock to the NW-TT, to obtain an updated transmission delay value, adds the updated transmission delay value to the CorrectionField of the time synchronization message (namely a total transmission delay of the message), and deletes the receiving time previous marked by the NW-TT. Then the modified time synchronization message is transmitted to the ES.

Based on the delay value marked on the time synchronization message by the DS-TT (namely the CorrectionField value on the time synchronization message), the ES may obtain a total transmission delay of the time synchronization message from the TSN grandmaster clock to the ES by directly adding the delay value on the time synchronization message to the transmission delay between the DS-TT and the ES. A calculated time value may be obtained by this total transmission delay plus the originTimestamp field value on the time synchronization message, and then the clock is set to this calculated time value, thereby achieving time synchronization between the ES on the UE side and the TSN GM clock.

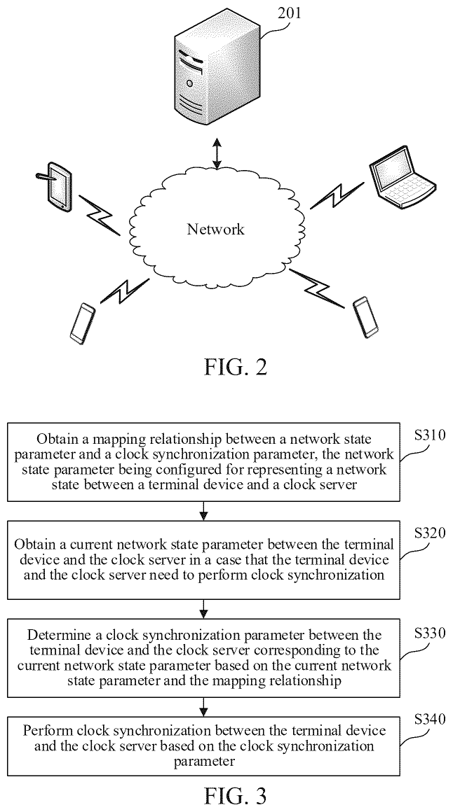

During the aforementioned time synchronization, an impact of a network state on synchronization performance is not considered. As a result, a long time synchronization process may be caused, and a signaling overload problem may be caused due to a large amount of interactive signaling. Based on this, a technical solution in an embodiment of this application provides a novel clock synchronization solution, so that a matching clock synchronization parameter may be selected based on a network state parameter, to avoid signaling overloads generated during clock synchronization to a maximum extent, reduce a time consumed for the clock synchronization, and improve clock synchronization efficiency. Specifically, as shown in FIG. 2, a server 201 is a clock server configured to provide a reference clock, and another terminal device performs clock synchronization with the clock server over a network.

Specifically, the server 201 may obtain a mapping relationship between the network state parameter and the clock synchronization parameter. The network state parameter is used for indicating a network state between another terminal device and the server 201. If the terminal device and the server 201 need to perform clock synchronization, a current network state parameter between the terminal device and the server 201 is obtained, then a current clock synchronization parameter between the terminal device and the server 201 is determined based on the current network state parameter and the foregoing determined mapping relationship, and then clock synchronization between the terminal device and the server 201 is performed based on the determined current clock synchronization parameter.

The terminal device may be a smartphone, a tablet computer, a notebook computer, a desktop computer, a smart television, a smart home, an in-vehicle terminal, an aircraft, or the like. The server 201 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device and the server 201 may be connected directly or indirectly in a wired communication manner or a wireless communication manner. This is not limited in this application.

The implementation details of the technical solution of the embodiment of this application are described in detail below

FIG. 3 is a flowchart of a clock synchronization method according to an embodiment of this application. The clock synchronization method may be performed by an electronic device. The electronic device may be a terminal device, or may be a clock server. Therefore, the clock synchronization method may be performed by the terminal device, or may be performed by the clock server, or may be performed by both the terminal device and the clock server. Referring to FIG. 3, the clock synchronization method includes at least operation S310 to operation S340. A detailed description is as follows.

Operation S310: Obtain a mapping relationship between a network state parameter and a clock synchronization parameter, the network state parameter being configured for representing a network state between a terminal device and a clock server.

In some embodiments, the network state parameter may be various parameters used for representing a network state between the terminal device and the clock server, and may be, for example, one or more of an uplink transmission delay between the terminal device and the clock server, a downlink transmission delay between the terminal device and the clock server, a total uplink and downlink transmission delay between the terminal device and the clock server, and a delay jitter parameter between the terminal device and the clock server. In some embodiments, the delay jitter parameter may be, for example, a standard deviation corresponding to a delay parameter (for example, the uplink transmission delay, the downlink transmission delay, or the total uplink and downlink transmission delay) obtained by measurement for a plurality of times.

In some embodiments, a process of obtaining the mapping relationship between the network state parameter and the clock synchronization parameter may be obtained in a statistical manner. Specifically, for example, a historical clock synchronization parameter between the terminal device and the clock server under each historical network state parameter during historical clock synchronization may be obtained, and then the mapping relationship between the network state parameter and the clock synchronization parameter may be determined based on the historical clock synchronization parameter between the terminal device and the clock server under each historical network state parameter.

The clock synchronization parameter is a parameter used when clocks of the terminal device and the clock server are adjusted to be consistent, and may include synchronization precision and a synchronization algorithm performance parameter.

In some embodiments, if the clock synchronization parameter is synchronization precision, statistics about synchronization precision that can be achieved under each historical network state parameter may be collected, and then the mapping relationship between the network state parameters and the synchronization precision may be generated based on the synchronization precision. In this case, if a current network state parameter is learned, synchronization precision that can be achieved under the current network state parameter may be obtained based on the mapping relationship, and then a corresponding synchronization algorithm performance parameter (such as a number of synchronizations in each round or a clock skew threshold for determining whether synchronization needs to be performed) may be set based on the synchronization precision, to implement the clock synchronization process between the terminal device and the clock server.

In some embodiments, if the clock synchronization parameter is a synchronization algorithm performance parameter, statistics about a synchronization algorithm performance parameter used under each historical network state parameter and an effect of clock synchronization (namely whether the synchronization precision is achieved) may be collected, an optimal synchronization algorithm performance parameter under each historical network state parameter may be obtained, and therefore, the mapping relationship between the network state parameter and the synchronization algorithm performance parameter is generated. In this case, if the current network state parameter is learned, an optimal synchronization algorithm performance parameter under the current network state parameter may be obtained based on the mapping relationship, and then the clock synchronization process between the terminal device and the clock server may be implemented based on the optimal synchronization algorithm performance parameter. The synchronization algorithm performance parameter is a parameter of a synchronization algorithm used for adjusting clocks of the terminal device and the clock server to be consistent. The synchronization algorithm parameter may include a parameter such as a clock synchronization skew threshold, a number of synchronizations in each round, or a synchronizing timer. The optimal synchronization algorithm performance parameter is a synchronization algorithm performance parameter that can achieve synchronization precision corresponding to the current network state parameter when the synchronization algorithm is run to perform clock synchronization on the terminal device and the clock server.

Operation S320: Obtain a current network state parameter between the terminal device and the clock server when the terminal device and the clock server need to perform clock synchronization.

In some embodiments, if a clock skew between the terminal device and the clock server is greater than or equal to a set skew threshold, it may be determined that the terminal device and the clock server need to perform clock synchronization. Alternatively, if duration between synchronization of the terminal device and the clock server and a previous round of synchronization reaches a set duration threshold, it may be determined that the terminal device and the clock server need to perform clock synchronization.

In some embodiments, a process of obtaining the current network state parameter between the terminal device and the clock server may be obtaining the current network state parameter between the terminal device and the clock server through capability exposure information provided by a network side device. For example, the network side device may collect statistics about the network state parameter between the terminal device and the clock server, and then provide capability exposure information to the outside by using a network exposure function (NEF), to provide the network state parameter between the terminal device and the clock server.

Operation S330: Determine a clock synchronization parameter between the terminal device and the clock server corresponding to the current network state parameter based on the current network state parameter and the mapping relationship.

In some embodiments, if the clock synchronization parameter includes synchronization precision, synchronization precision that can be achieved under the current network state parameter may be obtained based on the current network state parameter and the mapping relationship, and is used as the current clock synchronization parameter. The synchronization precision may be precision of synchronization performed between the terminal device and the clock server. For example, precision of clock synchronization may be millisecond synchronization precision.

In some embodiments, if the clock synchronization parameter includes a synchronization algorithm performance parameter, an optimal synchronization algorithm performance parameter between the terminal device and the clock server under the current network state parameter may be determined based on the current network state parameter and the mapping relationship, and then the determined optimal synchronization algorithm performance parameter is used as the current clock synchronization parameter.

Operation S340: Perform clock synchronization between the terminal device and the clock server based on the clock synchronization parameter.

In some embodiments, if the clock synchronization parameter includes synchronization precision, after the current synchronization precision is determined, a synchronization algorithm performance parameter between the terminal device and the clock server may be determined based on the current synchronization precision, and then clock synchronization between the terminal device and the clock server may be performed based on the determined synchronization algorithm performance parameter.

In some embodiments, if the clock synchronization parameter includes the synchronization algorithm performance parameter, after an optimal synchronization algorithm performance parameter between the terminal device and the clock server is determined, clock synchronization between the terminal device and the clock server may be performed based on the determined optimal synchronization algorithm performance parameter.

In some embodiments, a clock synchronization process between the terminal device and the clock server may be represented by different states, such as a clock hold state and a clock adjustment state. In the clock hold state, clock adjustment between the terminal device and the clock server is not needed, or only proper and fine adjustment is needed. In the clock adjustment state, clock adjustment between the terminal device and the clock server is needed.

In some embodiments, a process of performing clock synchronization between the terminal device and the clock server based on the current clock synchronization parameter may be as follows: a frequency of transmitting a synchronization probe packet is reduced, if it is determined, based on the current clock synchronization parameter, that a clock hold state needs to be entered. The synchronization probe packet is a data packet transmitted for performing clock synchronization during synchronization, and carries timestamp information. The timestamp information is configured for indicating a transmitting time of the data packet, so that a receiving party of the synchronization probe packet performs clock synchronization based on the timestamp information.

In some embodiments, if the clock skew between the terminal device and the clock server is less than or equal to a first skew threshold determined based on the current clock synchronization parameter, it indicates that there is a small clock skew between the terminal device and the clock server, and it may be determined that the clock hold state needs to be entered.

In some embodiments, if a number of clock synchronizations between the terminal device and the clock server in a current round reaches a synchronization number threshold determined based on the current clock synchronization parameter, it indicates that there is a large number of clock synchronizations between the terminal device and the clock server in the current round, and a clock synchronization requirement may be basically satisfied, or to avoid signaling overheads caused by continuous synchronization, it may be determined that the clock hold state needs to be entered.

In some embodiments, a process of performing clock synchronization between the terminal device and the clock server based on the current clock synchronization parameter may be as follows: a frequency of transmitting a synchronization probe packet is increased, if it is determined, based on the current clock synchronization parameter, that a clock adjustment state needs to be entered. In this embodiment, when the clock adjustment state is entered, the frequency of transmitting the synchronization probe packet is increased, so that clock synchronization efficiency can be increased based on a synchronization probe packet with a high frequency.

In some embodiments, if the clock skew between the terminal device and the clock server is greater than or equal to a second skew threshold determined based on the current clock synchronization parameter, it indicates that there is a large clock skew between the terminal device and the clock server, and it may be determined that the clock adjustment state needs to be entered. In some embodiments, the second skew threshold and the first skew threshold may be equal or not equal.

In some embodiments, if the duration between synchronization of the terminal device and the clock server and the previous round of synchronization reaches the duration threshold determined based on the current clock synchronization parameter, it indicates that the terminal device and the clock server perform no clock synchronization for a long time, and it may be determined that the clock adjustment state needs to be entered.

In the technical solutions provided in some embodiments of this application, a mapping relationship between the network state parameter and the clock synchronization parameter is obtained, then when the terminal device and the clock server need to perform clock synchronization, a current network state parameter between the terminal device and the clock server is obtained, and a current clock synchronization parameter between the terminal device and the clock server is determined based on the current network state parameter and the mapping relationship, to perform clock synchronization between the terminal device and the clock server based on the current clock synchronization parameter. Therefore, a matching clock synchronization parameter may be selected based on the network state parameter, to avoid signaling overloads generated by the clock synchronization process to a maximum extent, and reduce a time consumed for the clock synchronization, thereby improving clock synchronization efficiency.

The terminal device and the clock server in the embodiment of this application are relative. For example, the clock server may provide a reference clock to synchronize the terminal device, or the terminal device may provide a reference clock to synchronize the clock server. The clock server may be selected differently based on a network location of the clock server. For example, the clock server may be a UPF or a protocol data unit (PDU) session anchor (PSA) in a core network, or may be a base station in an access network, or may be an application server located in a cloud data center, or the like.

The implementation details of the technical solutions in the embodiments of this application are described in detail below with reference to FIG. 4 to FIG. 8.

In an embodiment of this application, an adaptive synchronization algorithm module may be provided. The synchronization algorithm module may be a virtual functional unit, or may be a physical functional device. The synchronization algorithm module may be arranged in a clock server, or may be arranged in a terminal device on which clock synchronization needs to be performed.

In some embodiments, as shown in FIG. 4, the synchronization algorithm module may run in different states, such as a clock hold state and a clock adjustment state. In some embodiments, if a skew between a local clock of the terminal device and a grandmaster clock (namely a clock of the clock server) has been reduced to a certain range (that is, a clock skew is less than a specific value, for example, the first skew threshold determined based on the current clock synchronization parameter), or the number of clock synchronization adjustments in the current round reaches a threshold, or a synchronizing timer does not overflow (if the synchronizing timer does not overflow, it indicates that a time for clock synchronization is not up, and clock synchronization needs to be performed after the synchronizing timer overflows), the clock hold state may remain.

If the skew between the local clock of the terminal device and the grandmaster clock expands to a certain range, or the synchronizing timer overflows, the clock adjustment state may be entered. In the clock adjustment state, the synchronization algorithm module may increase the frequency of transmitting the probe packet, to implement synchronization as soon as possible.

The foregoing two states may be mutually converted. For example, in the clock adjustment state, if the clock skew is reduced to a certain range (that is, the clock skew is less than the specific value) through adjustment, the clock hold state may be entered. In the clock hold state, if the skew between the local clock and the grandmaster clock expands to a certain range (that is, the clock skew is greater than a set value), or the synchronizing timer overflows, the clock adjustment state may be entered.

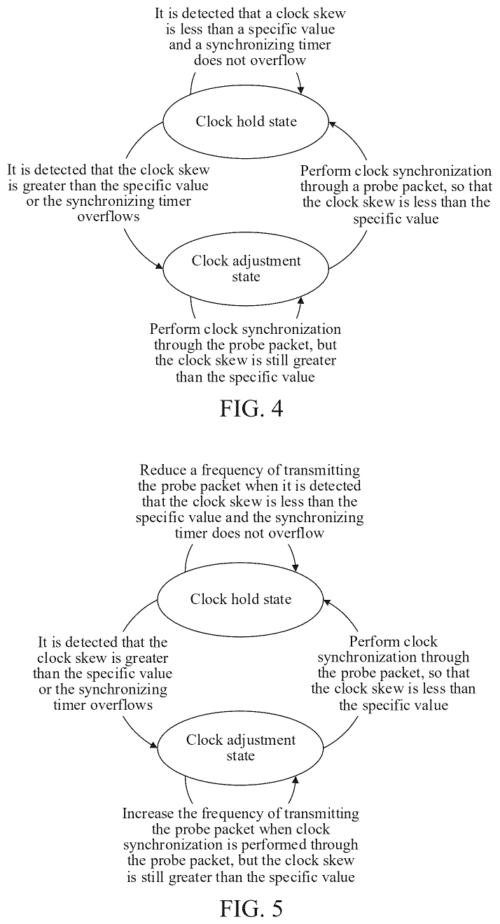

As shown in FIG. 5, if the skew between the local clock of the terminal device and the grandmaster clock is reduced to a certain range (that is, the clock skew is less than a specific value), or the number of clock synchronization adjustments in the current round reaches a threshold, or the synchronizing timer does not overflow, in a case of being in the clock hold state, the frequency of transmitting the probe packet may be reduced, or even the transmission of the probe packet is suspended, provided that synchronization is kept.

If the skew between the local clock of the terminal device and the grandmaster clock expands to a certain range, or the synchronizing timer overflows, when the clock adjustment state is entered, the frequency of transmitting the probe packet may be increased, so as to implement synchronization as soon as possible.

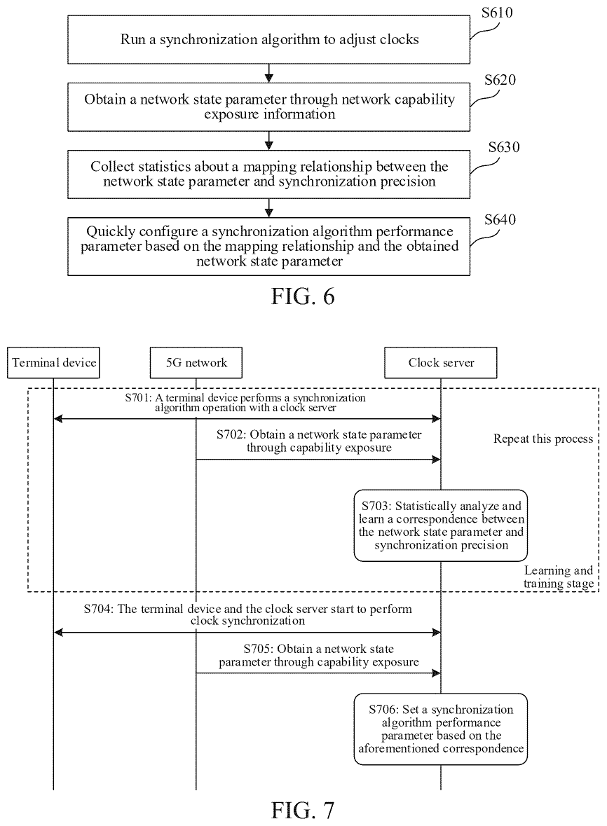

In some embodiments, the synchronization algorithm module may obtain synchronization precision corresponding to different network states through statistical analysis on the synchronization precision and the network state parameter, so as to set optimal synchronization algorithm performance parameters in different network states. Specifically, as shown in FIG. 6, the method includes the following operations:

Operation S610: Run a synchronization algorithm to adjust clocks.

In some embodiments, the synchronization algorithm may be run each time the terminal device and the clock server need to perform clock synchronization, to adjust the clocks of the terminal device and the clock server to be consistent.

Operation S620: Obtain a network state parameter through network capability exposure information.

In some embodiments, the network state parameter may be various parameters used for representing a network state between the terminal device and the clock server, and may be, for example, one or more of an uplink transmission delay between the terminal device and the clock server, a downlink transmission delay between the terminal device and the clock server, a total uplink and downlink transmission delay between the terminal device and the clock server, and a delay jitter parameter between the terminal device and the clock server. In some embodiments, the delay jitter parameter may be, for example, a standard deviation corresponding to a delay parameter (for example, the uplink transmission delay, the downlink transmission delay, or the total uplink and downlink transmission delay) obtained by measurement for a plurality of times.

Operation S630: Collect statistics about a mapping relationship between the network state parameter and synchronization precision.

In some embodiments, because the clock synchronization has a very direct relationship with a delay and jitter characteristic of a network, statistical analysis is performed on a correspondence between the network state parameter and the synchronization precision, so that the synchronization precision that can be achieved may be determined based on the network state parameter, thereby configuring a synchronization algorithm performance parameter, such as a clock synchronization skew threshold, a number of synchronizations in each round, and a synchronizing timer. That is, a synchronization algorithm performance parameter that can reach synchronization precision corresponding to the current network state parameter is an optimal synchronization algorithm performance parameter.

In some embodiments, when statistics about the mapping relationship between the network state parameter and the synchronization precision is collected, a relationship between the network state parameter and the synchronization precision may be learned in a machine learning manner. Alternatively, an association relationship between a range of each network state parameter and corresponding synchronization precision may be determined in a statistical manner, to obtain the mapping relationship between the network state parameter and the synchronization precision. For example, a first network state parameter range corresponds to first synchronization precision; and a second network state parameter range corresponds to second synchronization precision. When it is determined that the current network state parameter falls within the first network state parameter range, it is determined that the synchronization precision corresponding to the current network state parameter is the first synchronization precision.

Operation S640: Quickly configure a synchronization algorithm performance parameter based on the mapping relationship and the obtained network state parameter.

In some embodiments, after the synchronization algorithm performance parameter is rapidly configured according to the obtained network state parameter based on the mapping relationship between the network state parameter and the synchronization precision, switching may be performed between the clock hold state and the clock adjustment state in the manners shown in FIG. 4 and FIG. 5, to implement clock synchronization between the terminal device and the clock server.

In some embodiments, a process in which the terminal device interacts with the clock server over a 5G network in the technical solution shown in FIG. 6 is shown in FIG. 7, and includes the following operations:

Operation S701: A terminal device performs a synchronization algorithm operation with a clock server.

Specifically, a synchronization algorithm may be run each time the terminal device and the clock server need to perform clock synchronization, to adjust the clocks of the terminal device and the clock server to be consistent.

Operation S702: Obtain a network state parameter through capability exposure.

In some embodiments, the network state parameter may be various parameters used for representing a network state between the terminal device and the clock server, and may be, for example, one or more of an uplink transmission delay between the terminal device and the clock server, a downlink transmission delay between the terminal device and the clock server, a total uplink and downlink transmission delay between the terminal device and the clock server, and a delay jitter parameter between the terminal device and the clock server. In some embodiments, the delay jitter parameter may be, for example, a standard deviation corresponding to a delay parameter (for example, the uplink transmission delay, the downlink transmission delay, or the total uplink and downlink transmission delay) obtained by measurement for a plurality of times.

Operation S703: Statistically analyze and learn a correspondence between the network state parameter and synchronization precision.

In some embodiments, when statistics about the mapping relationship between the network state parameter and the synchronization precision is collected, a relationship between the network state parameter and the synchronization precision may be learned in a machine learning manner. Alternatively, an association relationship between a range of each network state parameter and corresponding synchronization precision may be determined in a statistical manner (such as repeatedly performing operation S701 to operation S703), to obtain the mapping relationship between the network state parameter and the synchronization precision.

In some embodiments, statistics about synchronization precision that can be reached by the terminal device and the clock server under each historical network state parameter during historical clock synchronization may be collected, and then the mapping relationship between each network state parameter and the synchronization precision may be determined based on each historical network state parameter and the synchronization precision that can be reached under the historical network state parameter.

Operation S704: The terminal device and the clock server start to perform clock synchronization.

In some embodiments, if a skew between a local clock of the terminal device and the clock server expands to a certain range, or a synchronizing timer overflows, it may be determined that the terminal device and the clock server need to perform clock synchronization.

Operation S705: Obtain a network state parameter through capability exposure.

In some embodiments, the network side device (such as a 5G core network element) may collect statistics about the network state parameter between the terminal device and the clock server, and then provide capability exposure information to the outside by using an NEF, to provide the network state parameter between the terminal device and the clock server.

Operation S706: Set a synchronization algorithm performance parameter based on the correspondence between the network state parameter and the synchronization precision.

In some embodiments, the synchronization algorithm performance parameter may be a parameter such as a clock synchronization skew threshold, a number of synchronizations in each round, or a synchronizing timer. After the synchronization algorithm performance parameter is set, transition may be performed between the clock hold state and the clock adjustment state in the manners shown in FIG. 4 and FIG. 5, to implement clock synchronization between the terminal device and the clock server. For example, after the synchronization precision that can be achieved by the network state parameter is determined, a synchronization algorithm performance parameter that is between the terminal device and the clock server and that can achieve the synchronization precision is determined based on the determined synchronization precision, and then clock synchronization between the terminal device and the clock server is performed based on the determined synchronization algorithm performance parameter.

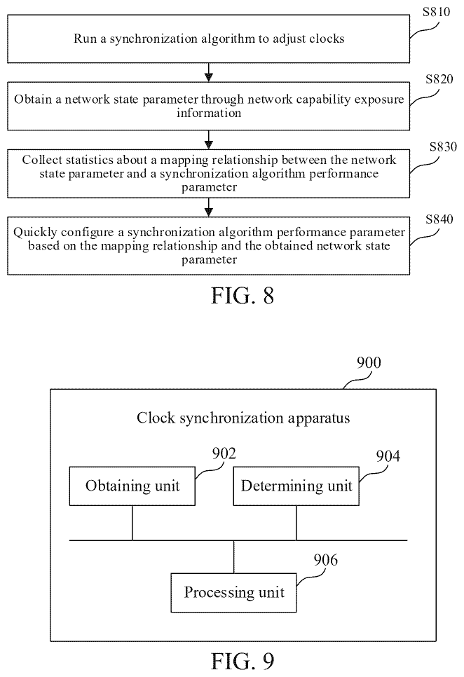

In addition to collecting statistics about the mapping relationship between the network state parameter and the synchronization precision, statistics about a mapping relationship between the network state parameter and the synchronization algorithm performance parameter may be further collected, so that the synchronization algorithm performance parameter may be directly set based on network capability exposure information, thereby reducing a convergence time needed for synchronization. Specifically, as shown in FIG. 8, the method includes the following operations:

Operation S810: Run a synchronization algorithm to adjust clocks.

In some embodiments, the synchronization algorithm may be run each time the terminal device and the clock server need to perform clock synchronization, to adjust the clocks of the terminal device and the clock server to be consistent.

Operation S820: Obtain a network state parameter through network capability exposure information.

In some embodiments, the network state parameter may be various parameters used for representing a network state between the terminal device and the clock server, and may be, for example, one or more of an uplink transmission delay between the terminal device and the clock server, a downlink transmission delay between the terminal device and the clock server, a total uplink and downlink transmission delay between the terminal device and the clock server, and a delay jitter parameter between the terminal device and the clock server. In some embodiments, the delay jitter parameter may be, for example, a standard deviation corresponding to a delay parameter (for example, the uplink transmission delay, the downlink transmission delay, or the total uplink and downlink transmission delay) obtained by measurement for a plurality of times.

Operation S830: Collect statistics about a mapping relationship between the network state parameter and a synchronization algorithm performance parameter.

In some embodiments, because the clock synchronization has a very direct relationship with a delay and jitter characteristic of a network, statistical analysis is performed on a correspondence between the network state parameter and the synchronization algorithm performance parameter, so that an optimal synchronization algorithm performance parameter, such as a clock synchronization skew threshold, a number of synchronizations in each round, and a synchronizing timer, may be directly configured based on the network state parameter.

In some embodiments, when statistics about the mapping relationship between the network state parameter and the synchronization algorithm performance parameter is collected, a relationship between the network state parameter and the synchronization algorithm performance parameter may be learned in a machine learning manner. Alternatively, an association relationship between a range of each network state parameter and a corresponding optimal synchronization algorithm performance parameter may be determined in a statistical manner, to obtain the mapping relationship between the network state parameter and the synchronization algorithm performance parameter. For example, a first network state parameter range corresponds to a first synchronization algorithm performance parameter; and a second network state parameter range corresponds to a second synchronization algorithm performance parameter. When it is determined that the current network state parameter falls within the second network state parameter range, it is determined that the optimal synchronization algorithm performance parameter corresponding to the current network state parameters is the second synchronization algorithm performance parameter.

Operation S840: Quickly configure a synchronization algorithm performance parameter based on the mapping relationship and the obtained network state parameter.

In some embodiments, after the synchronization algorithm performance parameter is rapidly configured according to the obtained network state parameter based on the mapping relationship between the network state parameter and the synchronization algorithm performance parameter, switching may be performed between the clock hold state and the clock adjustment state in the manners shown in FIG. 4 and FIG. 5, to implement clock synchronization between the terminal device and the clock server.

In the technical solution in the foregoing embodiment of this application, the synchronization algorithm performance parameter may be adjusted based on the network state parameter, so that a matching clock synchronization parameter may be selected based on the network state parameter, to avoid overloads of interactive signaling caused by the synchronization algorithm, reduce a time consumed for clock synchronization, and improve the clock synchronization efficiency. For example, through statistical analysis of synchronization algorithm precision and network state parameters, optimal parameters of synchronization algorithms corresponding to different network states, a convergence time needed for synchronization by using different synchronization algorithm performance parameters in different network states, and the like are obtained.

The following describes apparatus embodiments of this application, which may be configured for performing the clock synchronization method in the foregoing embodiment of this application. For details not disclosed in the apparatus embodiments of this application, reference may be made to the foregoing clock synchronization method embodiments of this application.

FIG. 9 is a block diagram of a clock synchronization apparatus according to an embodiment of this application. The clock synchronization apparatus may be arranged in a terminal device, a clock server, or both the terminal device and the clock server.

As shown in FIG. 9, a clock synchronization apparatus 900 according to an embodiment of this application includes an obtaining unit 902, a determining unit 904, and a processing unit 906.

The obtaining unit 902 is configured to obtain a mapping relationship between a network state parameter and a clock synchronization parameter, the network state parameter being configured for representing a network state between a terminal device and a clock server; and configured to obtain a current network state parameter between the terminal device and the clock server when the terminal device and the clock server need to perform clock synchronization; The determining unit 904 is configured to determine a clock synchronization parameter between the terminal device and the clock server corresponding to the current network state parameter based on the current network state parameter and the mapping relationship; and the processing unit 906 is configured to perform clock synchronization between the terminal device and the clock server based on the clock synchronization parameter.

In some embodiments of this application, based on the aforementioned solution, a process that the obtaining unit 902 obtains the mapping relationship between the network state parameter and the clock synchronization parameter includes: a historical clock synchronization parameter between the terminal device and the clock server under each historical network state parameter during historical clock synchronization is obtained; and the mapping relationship between the network state parameter and the clock synchronization parameter is determined based on the historical clock synchronization parameter between the terminal device and the clock server under each historical network state parameter.

In some embodiments of this application, based on the aforementioned solution, the clock synchronization parameter includes synchronization precision; and the processing unit 906 is configured to determine, based on the synchronization precision, a synchronization algorithm performance parameter that is between the terminal device and the clock server and that can achieve the synchronization precision; and perform the clock synchronization between the terminal device and the clock server based on the synchronization algorithm performance parameter.

In some embodiments of this application, based on the aforementioned solution, the clock synchronization parameter includes a synchronization algorithm performance parameter; and the determining unit is configured to determine a synchronization algorithm performance parameter between the terminal device and the clock server under the current network state parameter based on the mapping relationship; and use the synchronization algorithm performance parameter as the clock synchronization parameter.

In some embodiments of this application, based on the aforementioned solution, a process that the obtaining unit 902 obtains the current network state parameter between the terminal device and the clock server includes: the current network state parameter between the terminal device and the clock server is obtained through capability exposure information provided by a network side device.

In some embodiments of this application, based on the aforementioned solution, the processing unit 906 is configured to reduce a frequency of transmitting a synchronization probe packet, when it is determined, based on the clock synchronization parameter, that a clock hold state needs to be entered.

In some embodiments of this application, based on the foregoing solution, the processing unit 906 is further configured to determine that the clock hold state needs to be entered when a clock skew between the terminal device and the clock server is less than or equal to a first skew threshold determined based on the clock synchronization parameter.

In some embodiments of this application, based on the foregoing solution, the processing unit 906 is further configured to determine that the clock hold state needs to be entered when a number of clock synchronizations between the terminal device and the clock server in a current round reaches a synchronization number threshold determined based on the current clock synchronization parameter.

In some embodiments of this application, based on the aforementioned solution, the processing unit 906 is configured to increase a frequency of transmitting a synchronization probe packet, when it is determined, based on the clock synchronization parameter, that a clock adjustment state needs to be entered.

In some embodiments of this application, based on the foregoing solution, the processing unit 906 is further configured to determine that the clock adjustment state needs to be entered when a clock skew between the terminal device and the clock server is greater than or equal to a second skew threshold determined based on the clock synchronization parameter.

In some embodiments of this application, based on the foregoing solution, the processing unit 906 is further configured to determine that the clock adjustment state needs to be entered when duration between synchronization of the terminal device and the clock server and a previous round of synchronization reaches a duration threshold determined based on the clock synchronization parameter.

In some embodiments of this application, based on the foregoing solutions, the network state parameter includes at least one of the following: an uplink transmission delay between the terminal device and the clock server, a downlink transmission delay between the terminal device and the clock server, a total uplink and downlink transmission delay between the terminal device and the clock server, and a delay jitter parameter between the terminal device and the clock server.

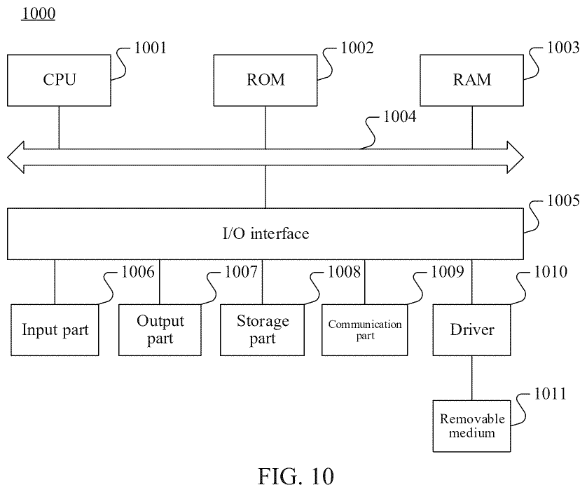

FIG. 10 is a schematic structural diagram of a computer system suitable for implementing an electronic device according to an embodiment of this application.

The computer system 1000 of the electronic device shown in FIG. 10 is merely an example, and does not constitute any limitation on functions and use ranges of the embodiments of this application.

As shown in FIG. 10, the computer system 1000 includes a central processing unit (CPU) 1001, which may perform various proper actions and processing based on a program stored in a read-only memory (ROM) 1002 or a program loaded from a storage part 1008 into a random access memory (RAM) 1003, for example, perform the method described in the foregoing embodiments. The RAM 1003 further has various programs and data required for system operation stored therein. The CPU 1001, the ROM 1002, and the RAM 1003 are connected to each other through a bus 1004. An input/output (I/O) interface 1005 is also connected to the bus 1004.

The following components are connected to the I/O interface 1005: an input part 1006 including a keyboard, a mouse, and the like; an output part 1007 including, for example, a cathode ray tube (CRT), a liquid crystal display (LCD), and a speaker; the storage part 1008 including a hard disk, or the like; and a communication part 1009 including a network interface card such as a local area network (LAN) card and a modem. The communication part 1009 performs communication processing by using a network such as the Internet. A driver 1010 is also connected to the I/O interface 1005 as required. A removable medium 1011, such as a magnetic disk, an optical disc, a magneto-optical disk, or a semiconductor memory, is installed on the driver 1010 as required, so that a computer program read from the removable medium is installed into the storage part 1008 as required.

Particularly, according to an embodiment of this application, the processes described in the following by referring to the flowcharts may be implemented as computer software programs. For example, an embodiment of this application includes a computer program product. The computer program product includes a computer program stored in a non-transitory computer-readable medium. The computer program includes a computer program configuring for performing the method shown in the flowchart. In such an embodiment, the computer program may be downloaded and installed from a network through the communication part 1009, and/or installed from the removable medium 1011. When the computer program is executed by the CPU 1001, the various functions defined in the system of this application are executed.

The computer-readable medium shown in the embodiments of this application may be a computer-readable signal medium or a computer-readable storage medium or any combination of the two. The computer-readable storage medium may be, for example, but is not limited to, an electric, magnetic, optical, electromagnetic, infrared, or semi-conductive system, apparatus, or device, or any combination of the above. More specific examples of the computer-readable storage medium may include but are not limited to an electrical connection with one or more wires, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any appropriate combination thereof. In this application, the computer-readable storage medium may be any tangible medium containing or storing a program, and the program may be used by or used in combination with an instruction execution system, apparatus, or device. In this application, the computer-readable signal medium may include a data signal transmitted in a baseband or as part of a carrier, and stores a computer-readable computer program. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The computer program included in the computer-readable medium may be transmitted by using any appropriate medium, including, but not limited to, a wireless medium, a wired medium, or any appropriate combination of the above.

The flowcharts and block diagrams in the accompanying drawings illustrate possible system architectures, functions, and operations that may be implemented by a system, a method, and a computer program product according to various embodiments of this application. Each box in a flowchart or a block diagram may represent a module, a program segment, or a part of code. The module, the program segment, or the part of code includes one or more executable instructions configured for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer program.

A related unit described in the embodiments of this application may be implemented in a software manner, or may be implemented in a hardware manner, and the unit described can also be set in a processor. Names of the units do not constitute a limitation on the units in a case.

In another aspect, this application further provides a computer-readable medium. The computer-readable medium may be included in the electronic device described in the above embodiments, or may exist alone without being assembled into the electronic device. The foregoing computer-readable medium carries one or more computer programs. The one or more computer programs, when executed by the electronic device, cause the electronic device to implement the methods described in the above embodiments.

Although a plurality of modules or units of a device configured to perform actions are discussed in the foregoing detailed description, such division is not mandatory. Actually, according to the implementations of this application, the features and functions of two or more modules or units described above may be specifically implemented in one module or unit. On the contrary, the features and functions of one module or unit described above may be further divided to be embodied by a plurality of modules or units.

According to the foregoing descriptions of the implementations, a person skilled in the art may readily understand that the exemplary implementations described herein may be implemented by using software, or may be implemented by combining software and necessary hardware. Therefore, the technical solutions of the embodiments of this application may be implemented in a form of a software product. The software product may be stored in a non-volatile storage medium (which may be a CD-ROM, a USB flash drive, a removable hard disk, or the like) or on a network, including several instructions for instructing a computing device (which may be a personal computer, a server, a touch terminal, a network device, or the like) to perform the methods according to the implementations of this application.

After considering the specification and practicing the implementations disclosed herein, a person skilled in the art may easily conceive of other implementations of this application. This application is intended to cover any variations, uses, or adaptive changes of this application. These variations, uses, or adaptive changes follow the general principles of this application and include common general knowledge or customary technical means in the art, which are not disclosed in this application.

This application is not limited to the precise structures described above and shown in the accompanying drawings, and various modifications and changes can be made without departing from the scope of this application. The scope of this application is subject only to the appended claims.

What is claimed is:

1. A clock synchronization method performed by an electronic device comprising:
obtaining a mapping relationship between a network state parameter and a clock synchronization parameter;
obtaining a current network state parameter between a terminal device and a clock server when the terminal device and the clock server need to perform clock synchronization, the current network state parameter representing a current network state between the terminal device and the clock server;
determining a clock synchronization parameter between the terminal device and the clock server corresponding to the current network state parameter based on the mapping relationship; and
performing clock synchronization between the terminal device and the clock server based on the clock synchronization parameter.

2. The method according to claim 1, wherein the obtaining a mapping relationship between a network state parameter and a clock synchronization parameter comprises:
obtaining a historical clock synchronization parameter between the terminal device and the clock server under each historical network state parameter during historical clock synchronization; and
determining the mapping relationship between the network state parameter and the clock synchronization parameter based on the historical clock synchronization parameter between the terminal device and the clock server under each historical network state parameter.

3. The method according to claim 1, wherein the clock synchronization parameter comprises synchronization precision; and
the performing clock synchronization between the terminal device and the clock server based on the clock synchronization parameter comprises:
determining, based on the synchronization precision, a synchronization algorithm performance parameter that is between the terminal device and the clock server and that achieves the synchronization precision; and
performing the clock synchronization between the terminal device and the clock server based on the synchronization algorithm performance parameter.

4. The method according to claim 1, wherein the clock synchronization parameter comprises a synchronization algorithm performance parameter; and
the determining a clock synchronization parameter between the terminal device and the clock server corresponding to the current network state parameter based on the current network state parameter and the mapping relationship comprises:
determining a synchronization algorithm performance parameter between the terminal device and the clock server under the current network state parameter based on the mapping relationship; and
using the synchronization algorithm performance parameter as the clock synchronization parameter.

5. The method according to claim 1, wherein the obtaining a current network state parameter between the terminal device and the clock server comprises:
obtaining the current network state parameter between the terminal device and the clock server through capability exposure information provided by a network side device.

6. The method according to claim 1, wherein the performing clock synchronization between the terminal device and the clock server based on the clock synchronization parameter comprises:
reducing a frequency of transmitting a synchronization probe packet, when it is determined, based on the clock synchronization parameter, that a clock hold state needs to be entered.

7. The method according to claim 6, further comprising:
determining that the clock hold state needs to be entered when a clock skew between the terminal device and the clock server is less than or equal to a first skew threshold determined based on the clock synchronization parameter.

8. The method according to claim 6, further comprising:
determining that the clock hold state needs to be entered when a number of clock synchronizations between the terminal device and the clock server in a current round reaches a synchronization number threshold determined based on the current clock synchronization parameter.

9. The method according to claim 1, wherein the performing clock synchronization between the terminal device and the clock server based on the clock synchronization parameter comprises:
increasing a frequency of transmitting a synchronization probe packet, when it is determined, based on the clock synchronization parameter, that a clock adjustment state needs to be entered.

10. The method according to claim 9, further comprising:
determining that the clock adjustment state needs to be entered when a clock skew between the terminal device and the clock server is greater than or equal to a second skew threshold determined based on the clock synchronization parameter.

11. The method according to claim 9, further comprising:
determining that the clock adjustment state needs to be entered when duration between synchronization of the terminal device and the clock server and a previous round of synchronization reaches a duration threshold determined based on the clock synchronization parameter.

12. The method according to claim 1, wherein the network state parameter comprises at least one of the following:
an uplink transmission delay between the terminal device and the clock server, a downlink transmission delay between the terminal device and the clock server, a total uplink and downlink transmission delay between the terminal device and the clock server, and a delay jitter parameter between the terminal device and the clock server.

13. An electronic device, comprising:
one or more processors; and
a memory, configured to store one or more computer programs, the one or more computer programs, when executed by the one or more processors, causing the electronic device to implement a clock synchronization method including:
obtaining a mapping relationship between a network state parameter and a clock synchronization parameter;
obtaining a current network state parameter between a terminal device and a clock server when the terminal device and the clock server need to perform clock synchronization, the current network state parameter representing a current network state between the terminal device and the clock server;
determining a clock synchronization parameter between the terminal device and the clock server corresponding to the current network state parameter based on the mapping relationship; and
performing clock synchronization between the terminal device and the clock server based on the clock synchronization parameter.

14. The electronic device according to claim 13, wherein the obtaining a mapping relationship between a network state parameter and a clock synchronization parameter comprises:
obtaining a historical clock synchronization parameter between the terminal device and the clock server under each historical network state parameter during historical clock synchronization; and
determining the mapping relationship between the network state parameter and the clock synchronization parameter based on the historical clock synchronization parameter between the terminal device and the clock server under each historical network state parameter.

15. The electronic device according to claim 13, wherein the clock synchronization parameter comprises synchronization precision; and
the performing clock synchronization between the terminal device and the clock server based on the clock synchronization parameter comprises:
determining, based on the synchronization precision, a synchronization algorithm performance parameter that is between the terminal device and the clock server and that achieves the synchronization precision; and
performing the clock synchronization between the terminal device and the clock server based on the synchronization algorithm performance parameter.

16. The electronic device according to claim 13, wherein the clock synchronization parameter comprises a synchronization algorithm performance parameter; and
the determining a clock synchronization parameter between the terminal device and the clock server corresponding to the current network state parameter based on the current network state parameter and the mapping relationship comprises:
determining a synchronization algorithm performance parameter between the terminal device and the clock server under the current network state parameter based on the mapping relationship; and
using the synchronization algorithm performance parameter as the clock synchronization parameter.

17. The electronic device according to claim 13, wherein the obtaining a current network state parameter between the terminal device and the clock server comprises:
obtaining the current network state parameter between the terminal device and the clock server through capability exposure information provided by a network side device.

18. The electronic device according to claim 13, wherein the performing clock synchronization between the terminal device and the clock server based on the clock synchronization parameter comprises:
reducing a frequency of transmitting a synchronization probe packet, when it is determined, based on the clock synchronization parameter, that a clock hold state needs to be entered.

19. The electronic device according to claim 13, wherein the network state parameter comprises at least one of the following:
an uplink transmission delay between the terminal device and the clock server, a downlink transmission delay between the terminal device and the clock server, a total uplink and downlink transmission delay between the terminal device and the clock server, and a delay jitter parameter between the terminal device and the clock server.

20. A non-transitory computer-readable medium, having a computer program stored therein, the computer program, when executed by a processor of an electronic device, causing the electronic device to implement a clock synchronization method including:
obtaining a mapping relationship between a network state parameter and a clock synchronization parameter;
obtaining a current network state parameter between a terminal device and a clock server when the terminal device and the clock server need to perform clock synchronization, the current network state parameter representing a current network state between the terminal device and the clock server;
determining a clock synchronization parameter between the terminal device and the clock server corresponding to the current network state parameter based on the mapping relationship; and
performing clock synchronization between the terminal device and the clock server based on the clock synchronization parameter.
